(19) United States
(12) Patent Application Publication
(10) Pub. No.: US 2010/0182374 A1
(43) Pub. Date: Jul. 22, 2010

(54) Printer

(75) Inventors: Yuji Nakagaki, Chiba (JP); Yohei Ogura, Chiba (JP)

Correspondence Address: CROWELL & MORING LLP;INTELLECTUAL PROPERTY GROUP, P.O. BOX 14300, WASHINGTON, DC, 20044-4300, US

(73) Assignee: Seiko Precision Inc., Narashino-shi (JP)

(21) Appl. No.: 12/663,376

(22) PCT Filed: Jun. 6, 2008
(86) PCT No.: PCT/JP2008/060499

§ 371 Date: Dec. 7, 2009

(30) Foreign Application Priority Data
Jun. 7, 2007 (JP) 2007-151378
Jun. 21, 2007 (JP) 2007-164128

(51) Int. Cl. B41J 2/165

(52) U.S. Cl. 347/35

(57) ABSTRACT

A printer comprises a platen roller (22), a print head (12) that ejects ink from nozzle holes to a print medium held by the platen roller (22), a maintenance mechanism (13) that cleans the print head (12), and an ejected ink receptacle (18) that absorbs and holds ink ejected and discarded from the print head (12) by the spit operation. The ejected ink receptacle (18) is placed on the side of the platen roller (22) opposite to the side where the maintenance mechanism (13) exists. The ejected ink receptacle (18) comprises a replaceably provided absorbent pad. When the print operation temporarily halts, the print head (12) moves to a position where it opposes the ejected ink receptacle (18) and performs the spit operation for ejecting and discarding ink inside the nozzle.

### TECHNICAL FIELD

The present invention relates to a printer and more particularly, to an inkjet printer.

### BACKGROUND ART

Some inkjet printers have a print head whose width is wider than that of the print region of a print medium. Inkjet printers of this type can perform high-speed printing because the print head thereof is exempt from having to move in the feeding direction of the print medium.

When ink resident in the print head of inkjet printers is left therein, the ink is solidified, and the solidified ink clogs nozzle holes. In response, an inkjet printer with a maintenance mechanism to clean the print head is proposed (see, e.g., Patent Literature 1).

This inkjet printer moves its print head in the same direction as the feeding direction of a print medium, such that the print head moves between the maintenance position, where the maintenance mechanism is disposed, and the printing position.

When the inkjet printer pauses for a long time—e.g., when the contents to be printed are changed—the maintenance mechanism covers the nozzle surface of the print head with a cap held by a cap unit so as to prevent the ink from being solidified.

When starting and ending the print operation, the maintenance mechanism expels the air inside the cap using a pump of the cap unit in order to aspirate and discharge ink inside the nozzle holes. Also, the maintenance mechanism scrapes ink residues on the nozzle surface using a wiper unit and then dissolves and cleans the remainder of the ink residues thereon using a cleaner unit.

### [Patent Literature 1] Unexamined Japanese Patent Application KOKAI Publication No. 2007-90612

### DISCLOSURE OF THE INVENTION

### Problem to be Solved by the Invention

For example, an inkjet printer that is provided in a production line to print a manufacturing date or the like on products temporarily has to stop its print operation due to production line circumstances. In such a situation, for example, when the print operation is paused for more than 30 seconds, ink resident in the print head eventually solidified, and the nozzle holes be clogged.

When the print operation is paused for more than a certain period of time, the maintenance mechanism moves the print head to the cap unit to periodically eject and discard the ink resident in the print head to inside the cap. This is called the spit operation.

There is no telling when the production line circumstance necessitates stopping of the print operation. When the print operation is temporarily halted and the spit operation is performed during removal of the maintenance mechanism (at least the cap unit), no cap unit is available to receive the ink ejected by the spit operation. The internal part of the printer and the print medium may be contaminated as ink is ejected to the inner part thereof. Therefore, cleaning and repair cannot be conducted when the maintenance mechanism is removed in the middle of the print operation.

Some printers are provided with a sensor to detect the maintenance mechanism so that the maintenance mechanism cannot be removed during the print operation. An extraneous cost is needed for equipping a sensor on such printers.

The present invention is made to address the above problem. The present invention is directed to providing a printer in which the internal part thereof and a print medium are not contaminated even when the maintenance mechanism is removed during the print operation.

### Means for Solving the Problem

The printer according to the present invention comprises:

a platen, wherein the platen holds a print medium;

a print head having nozzle holes, the print head capable of ejecting ink from the nozzle holes to the print medium held by the platen, the print head movable in a direction identical to a feeding direction of the print medium;

a maintenance mechanism, wherein the maintenance mechanism cleans the print head; and

an ejected ink receptacle placed to line up with the maintenance mechanism in the feeding direction, the ejected ink receptacle receiving and holding ink ejected and discarded from the print head.

It is preferable that the ejected ink receptacle comprises:

a tray; and

a pad contained in the tray, the pad absorbing and holding the ink ejected and discarded from the print head.

It is preferable that the pad is replaceable.

It is preferable that the printer according to the present invention further comprises:

a controller, wherein the controller carries the print head to a position opposing the ejected ink receptacle at a predetermined periodical timing and causes the print head to eject ink.

It is preferable that the printer according to the present invention further comprises:

a movement section, wherein the movement section moves the print head between a printing position, an ejecting position, and a maintenance position,

wherein at the printing position, the print head ejects ink to the print medium held by the platen for printing;

at the ejecting position, the print head ejects and discards ink resident in the print head to the ejected ink receptacle; and

at the maintenance position, the maintenance mechanism cleans the print head.

It is preferable that the printer according to the present invention is characterized in that a height of the print head at the ejecting position is substantially equal to a height of the print head at the printing position.

It is preferable that the ejected ink receptacle is placed such that movement of the print head is in one direction, which is caused by the movement section, thereby moving the print head from the printing position to the ejecting position or vice versa.

It is preferable that the platen is placed between the maintenance mechanism and the ejected ink receptacle.

### Effect of the Invention

The present invention can provide a printer in which the internal part thereof and a print medium are not contaminated even when the maintenance mechanism is removed during the print operation.

### BRIEF DESCRIPTION OF DRAWINGS

FIG. 1 is a partial perspective view of a printer in accordance with an embodiment of the present invention.

FIG. 2 is a cross-section view of a printer in accordance with an embodiment of the present invention.

FIG. 3 is a cross-section view of a print apparatus of a printer in accordance with an embodiment of the present invention, showing the state wherein the print head is in the printing position.

FIG. 4 is a cross-section view of the print apparatus of a printer in accordance with an embodiment of the present invention, showing the state wherein the print head is in the ejecting position where the print head ejects and discards the ink.

FIG. 5 is a cross-section view of the ejected ink receptacle.

### EXPLANATION OF REFERENCE NUMERALS

1 printer
10 print unit
11 chassis
12 print head
13 maintenance mechanism
131 cap unit
132 cleaner unit
133 wiper unit
14 nozzle surface
15 print head carrier
16 horizontal transport mechanism
17 vertical transport mechanism
18 ejected ink receptacle
20 feed unit
21 feed roller
22 platen roller
40 control unit
50 print medium
60 print head apparatus

### BEST MODE FOR CARRYING OUT THE INVENTION

Hereinafter, a printer in accordance with an embodiment of the present invention will be described with reference to the accompanying drawings.

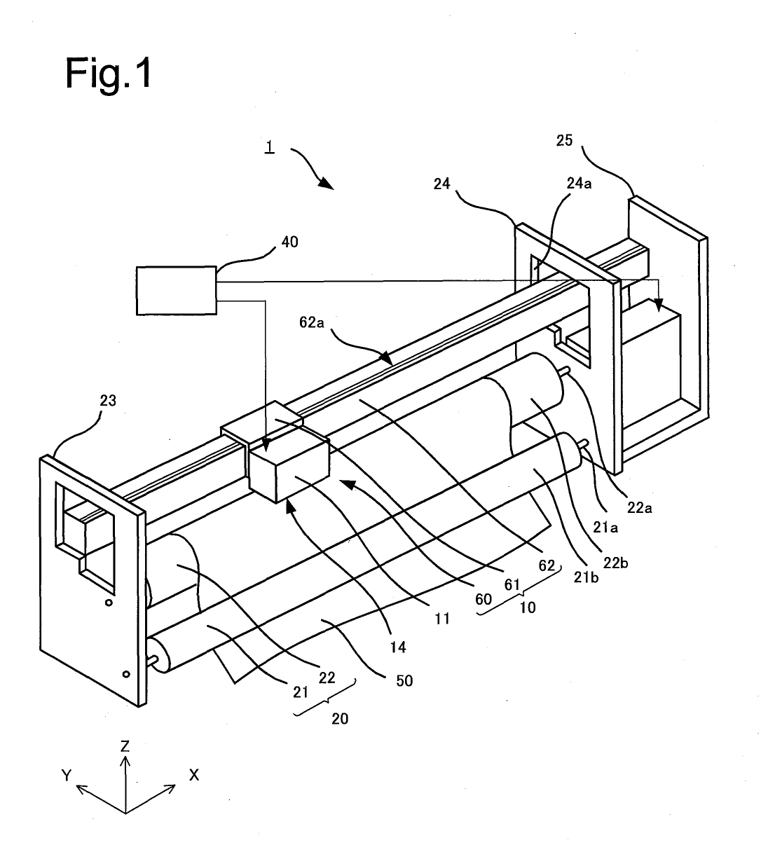

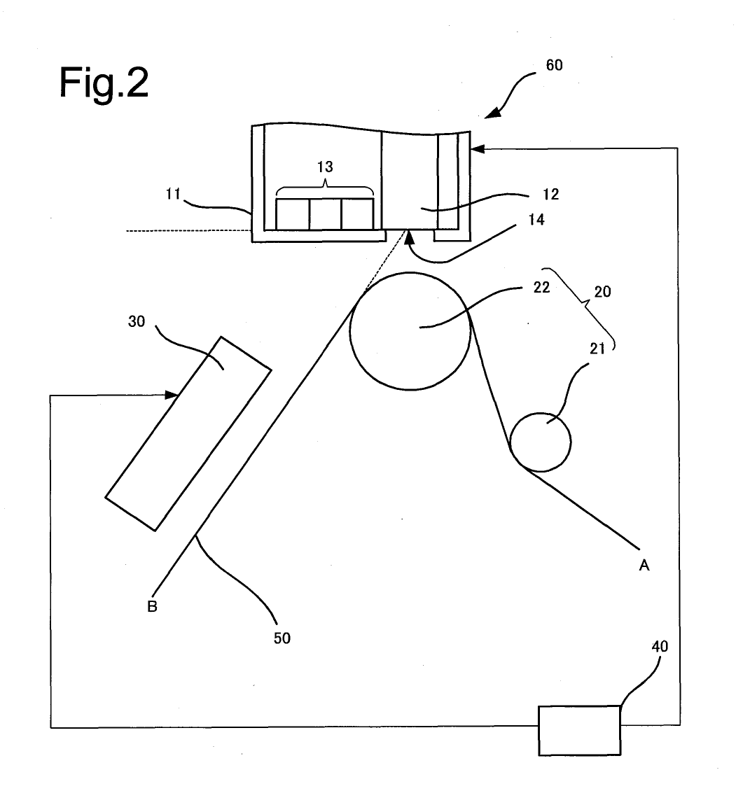

FIG. 1 is a partial perspective view of a printer 1 in accordance with an embodiment of the present invention. FIG. 2 is a cross-section view of the printer 1.

As illustrated in FIGS. 1 and 2, the printer 1 is made up of a print unit 10, a feed unit 20, a heating unit 30, and a control unit 40.

The print unit 10 includes a print head apparatus 60, a holder 61, and a holder guide 62.

The print head apparatus 60 houses components such as the print head 12 and the maintenance mechanism 13 in the interior of the chassis 11, and prints by ejecting ink from the print head 12 toward a print medium 50.

The chassis 11 is a member with an approximately rectangular solid shape that houses components such as the print head 12 and the maintenance mechanism 13. The chassis 11 includes an aperture (not shown in the drawings) on the bottom surface thereof, that exposes the nozzle surface 14 of the print head 12.

The holder 61 removably holds the print head apparatus 60. The holder 61 is joined to a belt (not shown in the drawings) driven by a motor not shown in the drawings. The holder 61 is thereby configured to be movable in the X direction (i.e., the lengthwise direction of the platen roller 22) along a guide rail 62a formed on the holder guide 62.

The holder guide 62 is a member with an approximately rectangular solid shape extending in the X direction. On the top surface of the holder guide 62 (the Z direction (i.e., the direction in which the print head 12 moves close to and away from the platen roller 22)), the guide rail 62a is formed along the lengthwise direction (X direction). The holder guide 62 passes through a window 24a in a floor board 24, with both ends secured to a floor board 23 and a support board 25.

The feed unit 20 includes a feed roller 21 and a platen roller 22, and carries the print medium 50 in at the A end and out at the B end.

The feed roller 21 includes an axis 21a and a cylindrical rotating section 21b. The axis 21a is disposed approximately horizontally in the X direction, with both ends secured to the floor boards 23 and 24, respectively. The rotating section 21b is rotatably disposed around the secured axis 21a thus fixed.

The platen roller 22 includes an axis 22a and a cylindrical rotating section 22b. The axis 22a is disposed approximately horizontally in the X direction, with both ends rotatably supported by the floor boards 23 and 24, respectively.

The floor boards 23 and 24 are disposed parallel to each other and orthogonal to the axes 21a and 22a.

The heating unit 30 is disposed on the B-end side of the feeding path of the print medium 50 and facing the print medium 50. The heating unit 30 heats and dries the print medium 50 to which ink has been applied.

The control unit 40 is made up of an MPU (Micro Processing Unit) and various types of memory, such as ROM (Read-Only Memory), RAM (Random Access Memory), and flash memory.

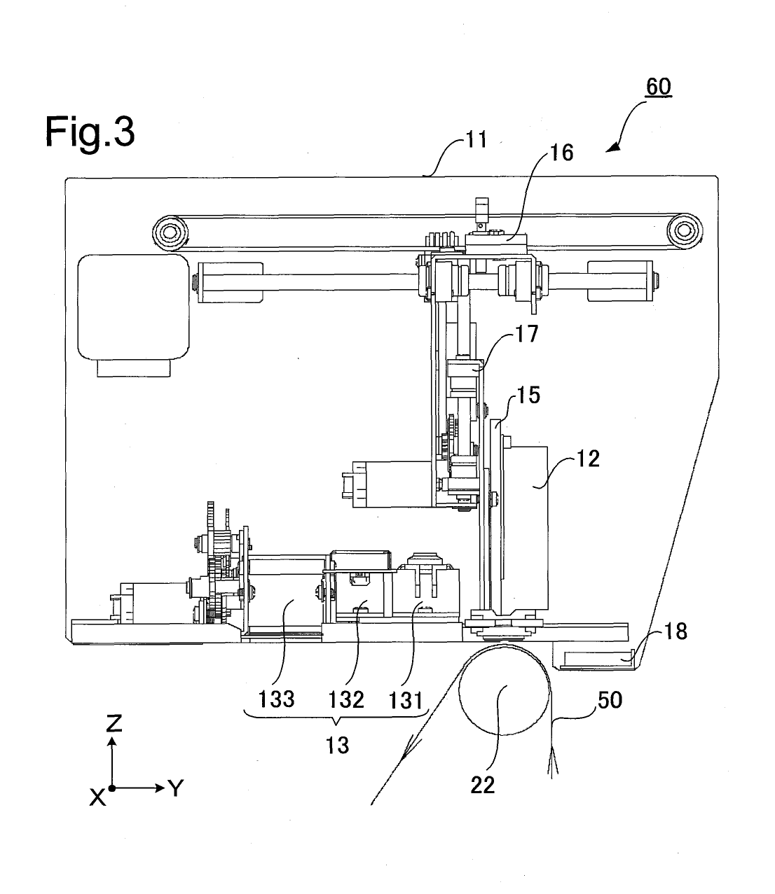

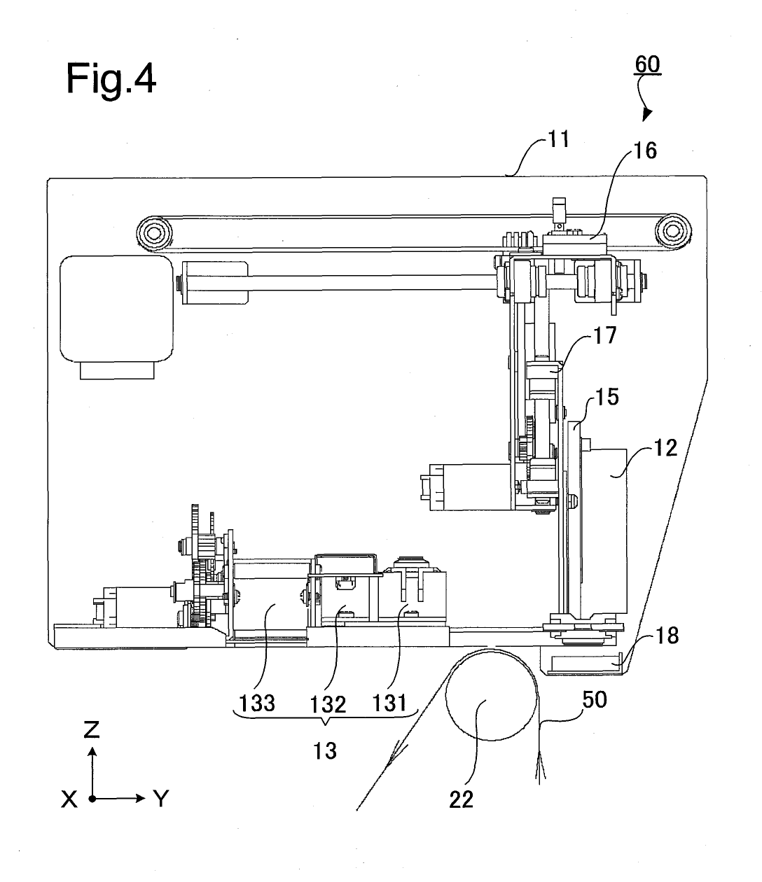

FIGS. 3 and 4 are cross-section diagrams of the print apparatus 60 in the printer 1 shown in FIG. 1. FIG. 3 illustrates the state wherein the print head 12 is in the printing position. For printing, the print head 12 ejects ink to the print medium 50 at the printing position. FIG. 4 illustrates the state wherein the print head 12 is in the ejecting position. The print head 12, at the ejecting position, ejects and discards ink resident in the print head (i.e., performing the spit operation). As illustrated in FIGS. 3 and 4, the print apparatus 60 comprises, not only the chassis 11 and the print head 12, which are mentioned above, but also the print head carrier 15, the horizontal transport mechanism 16, the vertical transport mechanism 17, and the ejected ink receptacle 18.

The print head 12 has an approximately rectangular solid shape, and on the bottom surface thereof (i.e., the nozzle surface 14), a plurality of nozzle holes (not shown in the drawings) that eject ink supplied from ink cartridges not shown in the drawings are formed at predetermined intervals along the lengthwise direction (X direction) of the nozzle surface 14. Also, the print head 12 has a width wider than the width of the print region of the print medium so as to perform printing at high speeds. Therefore, printing can be performed without having to cause the print head 12 to move in the direction in which the platen roller 22 extends (X direction).

The maintenance mechanism 13 is provided with a cap unit 131, a cleaner unit 132 and and a wiper unit 133. The cap unit 131, the cleaner unit 132, and the wiper unit 133 are disposed in series in the direction in which the print medium is fed—i.e., the Y direction (i.e., the direction orthogonal to the direction in which the print head 12 moves close to and away from the platen roller 22, and orthogonal to the direction in which the platen roller 22 extends).

The cap unit 131 holds a cap that covers the nozzle surface 14 of the print head 12 and that prevents drying of the nozzle holes. In addition, the cap unit 131 creates a low-pressure state by drawing air out from inside the cap with a pump not shown in the drawings, thus aspirating and discharging ink out of the nozzle holes of the print head 12.

After the cap unit 131 has aspirated and discharged ink out of the nozzle holes of the print head 12, the wiper unit 133 scrapes ink remaining on the nozzle surface 14. The wiper unit 133 is provided with a scraper made of rubber or urethane.

After the wiper unit 133 scrapes ink, the cleaner unit 132 dissolves and cleans off ink remaining on the nozzle surface 14. The cleaner unit 132 is made up of a compressible, porous material such as urethane foam impregnated with a cleaning fluid (i.e., solvent) that dissolves ink, as well as a case that houses the porous material.

The print head carrier 15 holds the print head 12 such that the nozzle surface 14 thereof faces the platen roller 22.

The horizontal transport mechanism 16 and the vertical transport mechanism 17 move the print head 12 in the horizontal direction (Y direction) and in the vertical direction (Z direction), respectively.

The horizontal transport mechanism 16 and the vertical transport mechanism 17 move the print head 12 between the printing position, the ejecting position, and the maintenance position. At the printing position, the print head 12 ejects ink to the print medium 50 held by the platen roller 22 for printing. At the ejecting position, the print head 12 ejects and discards ink resident in the print head 12 to the receptacle 18. At the maintenance position, cleaning of ink resident in the print head 12 is conducted by the maintenance mechanism 13, which comprises the cap unit 131, the cleaner unit 132, and the wiper unit 133. In other words, the horizontal transport mechanism 16 and the vertical transport mechanism 17 move the print head 12 to the maintenance and ejecting positions not for printing, but for purposes other than printing.

Secured to the chassis 11, the horizontal transport mechanism 16 supports the vertical transport mechanism 17 and transports the vertical transport mechanism 17 in the horizontal direction (the Y direction).

The vertical transport mechanism 17 supports the print head carrier 15 and transports the print head carrier 15 in the vertical direction (the Z direction).

The receptacle 18 receives and stores ink ejected and discarded from the print head 12 by the spit operation. The receptacle 18 has a structure to dispose of the stored ink.

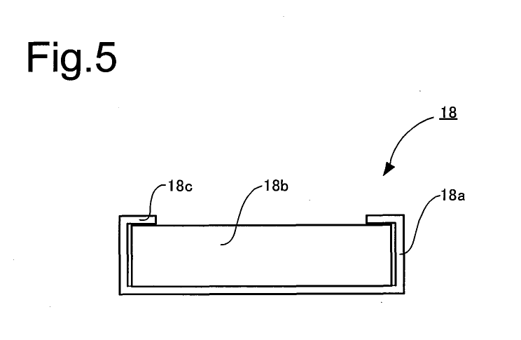

The receptacle 18 is made up of a tray 18a and a sponge-shaped (i.e., a porous material) absorbent pad 18b housed in the tray 18a, as illustrated in FIG. 5. Since the receptacle 18 is separate from the maintenance mechanism 13, the receptacle 18 is not affected by removal of the maintenance mechanism 13.

The top end of the peripheral wall of the tray 18a is bent in the inward horizontal direction, and functions as guards 18c that hold down the absorbent pad 18b. The tray 18a is slidable along a guide groove (not shown) provided on the chassis 11 and can be easily fit removably to the chassis 11. By pulling an absorbent pad 18b out from between the guard 18c and inserting an absorbent pad 18b in between the guard 18c, the absorbent pad 18b can be replaced. It should be appreciated that the absorbent pad 18b is not limited to a porous material, and may also be an absorber that works by chemical reactions, such as a polymer absorber, for example.

When the printer is paused, the spit operation causes the print head 12 to eject and discard ink into the receptacle 18. In a spit operation, ink inside the nozzle holes of the print head 12 is not aspirated and discharged. For this reason, it is not necessary for the receptacle 18 to include a pump or the like that reduces pressure by drawing air out from inside the cap like the cap unit 131. The construction of the receptacle 18 is simple, and the receptacle 18 can be made shallow.

As illustrated in FIGS. 3 and 4, the receptacle 18 is, for example, disposed near the platen roller 22 and faces the maintenance mechanism 13 with the platen roller 22 in the middle. Also, the receptacle 18 is placed such that the top surface thereof (e.g., the top surface of the absorbent pad 18b) is slightly lower than the top surface of the platen roller 22. By disposing the receptacle 18 in this manner, when the print head 12 is moved in the horizontal direction (the Y direction) and positioned over the receptacle 18, the top surface of the receptacle 18 and the nozzle surface 14 of the print head 12 do not touch. In other words, the print head 12 is moved from the printing position to the ejecting position simply by moving in the horizontal direction (the Y direction) by means of the horizontal transport mechanism 16. Similarly, the print head 12 returns to the printing position from the ejecting position simply by moving in the horizontal direction (the Y direction).

Next, the operation of the printer 1 having the above configuration will be described.

The normal print operation of the printer 1 is the same as that of conventional printers. The text to follow explains the spit operation, which is characteristic of this embodiment.

(1) If feeding of the print medium 50 stops due to conditions in an upstream or downstream process or other factors, then the control unit 40 may, for example, use the output of a rotary encoder installed on the platen roller 22 to determine that feeding of the print medium 50 has stopped. In response to this determination, the control unit 40 pauses operation of the printer 1, and puts the print head 12 in the printing position shown in FIG. 3.
(2) Upon the stopping of the print operation by the printer 1, the control unit 40 activates a timer (not shown), such as a software timer embedded in the control unit 40.
(3) With printing in the stopped state, the timer waits for a lapse of a predetermined amount of time (i.e., a degree of time during which the ink inside the nozzle holes of the print head 12 will not coagulate, such as 20 to 30 sec). If the print operation does not resume after a lapse of the predetermined amount of time, then the control unit 40 drives the horizontal transport mechanism 16 in the Y direction and transports the print head 12 to a position directly above the receptacle 18 (i.e., the ejecting position), as illustrated in FIG. 4. As described earlier, the height of the top surface of the receptacle 18 is lower than the top surface of the platen roller 22, and thus the height of the print head 12 is equal at the printing position and the ejecting position. For this reason, the print head 12 can be moved from the printing position to the ejecting position simply by moving in the horizontal direction (the Y direction) by means of the horizontal transport mechanism 16.
(4) The control unit 40 conducts a spit operation to cause the print head 12 to aspirate and discharge ink. More specifically, the control unit 40 drives the print head 12 to discharge ink accumulated inside the print head 12 towards the receptacle 18. In addition, the receptacle 18 receives and retains the discharged ink in the absorbent pad 18b.
(5) When discharge (the spit operation) of the ink is completed, the control unit 40 again drives the horizontal transport mechanism 16 and returns the print head 12 to the printing position shown in FIG. 3.
(6) When the print head 12 returns to the printing position, the control unit 40 resets and reactivates the timer, and repeats steps (3) to (6) above until the printer 1 resumes the print operation.

As the amount of ink that can be held by the absorbent pad 18b of the receptacle 18 is limited, the user must replace the absorbent pad 18b on a regular or as-needed basis. The replacement of the absorbent pad 18b takes little time and effort as it can be done only by sliding the tray 18a, removing it from the chassis 11, replacing the absorbent pad 18b with a new one, and sliding the tray 18a back to the chassis 11. Even if this replacement is conducted during the print operation during which the spit operation is not conducted, problems, such as contamination of the internal part of the printer, do not arise.

Also, the control unit 40 may be set to inform the user of the time when the absorbent pad 18b needs to be replaced.

The printer 1 according to the above embodiment performs the spit operation above the receptacle 18. Therefore, the maintenance mechanism 13 is used exclusively for cleaning the print head 12, e.g., at the time of start-up or after a long stopping of the print operation.

To perform clearing at the time of start-up or after a long stopping of the print operation, the control unit 40 moves the print head 12 to the position of the cap unit 131 and mount the cap unit 131 on the print head 12. The control unit 40 subsequently reduces the internal pressure of the cap unit 131 and causes solidified ink inside the print head 12 to be aspirated and discharged.

The control unit 40 in turn moves the print head 12 to the position of the wiper unit 133. Then the control unit 40 uses the wiper unit 133 to scrape ink residuals on the nozzle surface of the print head 12 by a scraper.

The control unit 40 subsequently moves the print head 12 to the cleaner unit 132. Then the control unit 40 brings the nozzle surface 14 into contact with a cleaning pad inside the cleaner unit 132 in order to clean the nozzle surface 14.

In addition, the control unit 40 moves the print head 12 to the cap unit 131 when the print operation is expected to stop for a long time—i.e., when the electric power of the printer 1 is turned off. To prevent the nozzle surface 14 from being dried, the control unit 40 mounts the cap unit 131 on the print head 12.

As explained above, the printer 1 according to the present embodiment is provided with the receptacle 18, which is separate from the maintenance mechanism 13. The control unit 40 causes the absorbent pad 18b to absorb and hold ink during the spit operation. The maintenance mechanism 13 may be used exclusively for cleaning the print head 12. Even when the maintenance mechanism 13 is removed during the print operation and the spit operation is launched, the print head 12 does not come to the maintenance mechanism 13. Therefore, the maintenance mechanism 13 can be cleaned or repaired during the print operation. The need is obviated for providing a sensor or removal prevention mechanism for preventing the maintenance mechanism 13 from being removed during the print operation.

Also, the absorbent pad 18b is replaceable, and its replacement is effortless. Since the time taken for replacing the absorbent pad 18b is little, the user can replace the absorbent pad 18b during the print operation without having to stop the print operation.

In addition, the receptacle 18 is only used to absorb and hold, in the absorbent pad 18b, ink ejected and discarded by the spit operation, so the receptacle 18 may be made to have a small thickness. The receptacle 18 may be placed at a position where the print head 12 can be caused to move only by moving the horizontal transport mechanism 16 from the printing position in the horizontal direction (Y direction). Such placement frees the print head 12 from making movements in the vertical direction. The time taken for the spit operation can be thereby reduced.

The present invention is not limited to the above embodiment and can be modified or applied in various ways.

In the above embodiment, the peak of the platen roller 22 and the top surface of the receptacle 18 are approximately the same height. However, height in the present invention does not mean height in the direction of gravity, but rather means height based on the horizontal direction (the Y direction) in which the print head 12 is moved by the horizontal transport mechanism 16. In FIGS. 3 and 4, the aforementioned height means the height in the Z direction, and thus in the case where the printer 1 itself is disposed in a tilted position, the horizontal line becomes similarly tilted.

In the above embodiment, the receptacle 18 is made up of a tray 18a, an absorbent pad 18b, and guards 18c. However, an arbitrary configuration can be adopted, as long as the configuration of the receptacle 18 is able to receive, absorb, and hold ink that has been ejected and discarded by the spit operation and can be automatically or manually replaced in little time with little effort. For example, the receptacle 18 may be configured to have a socket that receives ejected and discarded ink, and a container (tank) that stores ink.

In addition, in the above embodiment, the platen roller 22 is disposed between the cap unit 131 and the receptacle 18. However, the installation position of the receptacle 18 is not limited to the above. For example, the receptacle 18 may also be disposed between the platen roller 22 and the cap unit 131.

Furthermore, it is not necessary for the absorbent pad 18b to be maintained at the same approximate height as the platen roller 22, and the absorbent pad 18b may be disposed in a position shifted from the platen roller 22 in the Z direction. In this case, however, when moving the print head 12, movement is required not only in Y direction, but also in Z direction. To be free from having to make movements in Z direction, it is preferable for the top surfaces of the absorbent pad 18b and the platen roller 22 to be at approximately the same height.

In addition, the configuration of the maintenance mechanism 13 is arbitrary, and can be suitably modified.

The timing of spit operation performance is arbitrary as well and should be appropriately selected according to the environment in which the printer 1 operates.

Herein, a platen refers to a member that holds a print medium at a regular position. The platen is not limited to having a roller shape like the platen roller 22, and may also have a shape of cylinder or plate or to be non-rotatable.

In the above embodiment, when the discharge of old ink is completed, the control unit 40 again uses the horizontal transport mechanism 16 to return the print head 12 to the printing position shown in FIG. 3. However, when the discharge of old ink is completed, it is not strictly necessary for the control unit 40 to return the print head 12 to the printing position. When the discharge of old ink is completed, the control unit 40 may also keep the print head 12 at the ejecting position shown in FIG. 4 and discharge ink accumulated inside the print head 12 into the receptacle 18 every time a predetermined amount of time elapses. The control unit 40 may also eject and discard ink immediately before resuming printing, and then subsequently use the horizontal transport mechanism 16 to return the print head 12 to the printing position shown in FIG. 3. In so doing, the quality of printing can be improved.

The embodiment of the present invention has been explained above. However, based on design considerations and other relevant factors, a variety of modifications may be made to the embodiment, and combinations thereof may be made. Such modifications and combinations should be considered to fall within the scope of the present invention, which is along the lines with specific examples of the invention as claimed in the claims and as described in the Best Mode for Carrying out the Invention.

The present application is based on Japanese Patent Application No. 2007-151378, whose filing date is Jun. 7, 2007, as well as on Japanese Patent Application No. 2007-164128, whose filing date is Jun. 21, 2007. The specifications, claims, and drawings of these applications are incorporated herein in their entirety by reference.

### INDUSTRIAL APPLICABILITY

The present invention can be used in printers.

1. A printer comprising:
a platen, wherein the platen holds a print medium;
a print head having nozzle holes, the print head capable of ejecting ink from the nozzle holes to the print medium held by the platen, the print head movable in a direction identical to a feeding direction of the print medium;
a maintenance mechanism, wherein the maintenance mechanism cleans the print head; and
an ejected ink receptacle placed to line up with the maintenance mechanism in the feeding direction, the ejected ink receptacle receiving and holding ink ejected and discarded from the print head.

2. The printer according to claim 1,
wherein the ejected ink receptacle comprises:
a tray; and
a pad contained in the tray, the pad absorbing and holding the ink ejected and discarded from the print head.

3. The printer according to claim 2,
wherein the pad is replaceable.

4. The printer according to claim 1 further comprising:
a controller, wherein the controller carries the print head to a position opposing the ejected ink receptacle at a predetermined periodical timing and causes the print head to eject ink.

5. The printer according to claim 1 further comprising:
a movement section, wherein the movement section moves the print head between a printing position, an ejecting position, and a maintenance position,
wherein at the printing position, the print head ejects ink to the print medium held by the platen for printing;
at the ejecting position, the print head ejects and discards ink resident in the print head to the ejected ink receptacle; and
at the maintenance position, the maintenance mechanism cleans the print head.

6. The printer according to claim 5,
wherein a height of the print head at the ejecting position is substantially equal to a height of the print head at the printing position.

7. The printer according to claim 5,
wherein the ejected ink receptacle is placed such that movement of the print head is in one direction, which is caused by the movement section, thereby moving the print head from the printing position to the ejecting position or vice versa.

8. The printer according to claim 1,
wherein the platen is placed between the maintenance mechanism and the ejected ink receptacle.
